(19) United States
(12) Patent Application Publication
(10) Pub. No.: US 2019/0190143 A1
(43) Pub. Date: Jun. 20, 2019

(54) APPARATUS AND METHOD FOR USE IN CONTROLLING THE POSITIONING OF AN ANTENNA

(71) Applicant: Nokia Technologies Oy, Espoo (FI)

(72) Inventors: Jani MOILANEN, Helsinki (FI); Teemu VEIJALAINEN, Helsinki (FI)

(21) Appl. No.: 16/207,736

(22) Filed: Dec. 3, 2018

(30) Foreign Application Priority Data
Dec. 15, 2017 (FI) PCT/FI2017/050903

(51) Int. Cl. H01Q 3/02; H04B 17/309

(52) U.S. Cl. CPC H01Q 3/02; H04B 17/309

(57) ABSTRACT

An apparatus comprising a processor and memory including computer program code, the memory and computer program code configured to, with the processor, enable the apparatus at least to:
map the value of a radio channel key performance indicator throughout a generally repeating cycle for two or more positions of an antenna of a first device, the value of the radio channel key performance indicator varying with changes in a radio environment between the first device and a second device for a given antenna position; and
use the mapped value of the radio channel key performance indicator to determine at least one position of the antenna for use in controlling the positioning of the antenna to achieve at least one acceptable value of the radio channel key performance indicator.

### TECHNICAL FIELD

The present disclosure relates to an apparatus and associated method for use in controlling the positioning of an antenna of a first device to achieve at least one acceptable value of a radio channel key performance indicator which varies with changes in a radio environment between the first device and a second device for a given antenna position. In some examples, the apparatus is configured to map the value of the radio channel key performance indicator throughout a generally repeating cycle for two or more positions of the antenna of the first device, and use the mapped value of the radio channel key performance indicator to determine at least one position of the antenna for use in controlling the positioning of the antenna to achieve the at least one acceptable value of the radio channel key performance indicator.

### BACKGROUND

Research is currently being done to develop Fifth Generation (5G) wireless networks.

The listing or discussion of a prior-published document or any background in this specification should not necessarily be taken as an acknowledgement that the document or background is part of the state of the art or is common general knowledge.

### SUMMARY

According to a first aspect, there is provided an apparatus comprising a processor and memory including computer program code, the memory and computer program code configured to, with the processor, enable the apparatus at least to:
map the value of a radio channel key performance indicator throughout a generally repeating cycle for two or more positions of an antenna of a first device, the value of the radio channel key performance indicator varying with changes in a radio environment between the first device and a second device for a given antenna position; and
use the mapped value of the radio channel key performance indicator to determine at least one position of the antenna for use in controlling the positioning of the antenna to achieve at least one acceptable value of the radio channel key performance indicator.

The apparatus may be configured to use the mapped value of the radio channel key performance indicator to determine respective positions of the antenna at different stages of the generally repeating cycle for use in controlling the positioning of the antenna to achieve an acceptable value of the radio channel key performance indicator at each of said different stages.

The apparatus may be configured to use the mapped value of the radio channel key performance indicator to determine a fixed position of the antenna throughout the generally repeating cycle for use in controlling the positioning of the antenna to achieve the at least one acceptable value of the radio channel key performance indicator.

The at least one acceptable value of the radio channel key performance indicator may be an optimum value, a particular value, an average value, a value which is greater or less than a threshold value, or a range of values.

The apparatus may be configured to map one or more of the absolute value, change in value, direction of change in value and rate of change in value of the radio channel key performance indicator throughout the generally repeating cycle.

The cycle in the value of the radio channel key performance indicator may at least generally repeat in one or more of time, space and state of the radio environment. In some cases, the cycle may repeat exactly or substantially in one or more of time, space and state of the radio environment.

The value of the radio channel key performance indicator may vary with one or more of the following changes in the radio environment:
the distance between the antenna of the first device and an antenna of the second device;
the orientation of the antenna of the first device and/or the antenna of the second device;
the presence, number, positioning and/or activity of interfering devices located within the radio environment;
the presence, number and/or positioning of objects located within the radio environment; and
the atmospheric conditions and/or composition within the radio environment.

The radio channel key performance indicator may comprise one or more of signal strength, pathloss, reference signal received power, reference signal received quality, received signal strength indicator, reliability, latency, jitter, coverage, capacity, data transfer rate, rank indicator, modulation and coding scheme indicator, and level of interference.

The apparatus may be configured to control the positioning of the antenna according to the at least one determined position of the antenna.

The apparatus may be configured to control one or more of the location and orientation of the antenna.

The apparatus may be configured to control the location of the antenna in one, two or three dimensions.

The apparatus may be configured to control the orientation of the antenna about one or more axes.

The antenna may be attached to a mobility platform such that it can be positioned independently of the position of the first device in response to a control signal generated by the apparatus.

The antenna may be external or integral to the first device.

The first device may comprise a plurality of antennas, and the apparatus may be configured to determine and control the positioning of each antenna to achieve the at least one acceptable value of the radio channel key performance indicator.

Each antenna may be attached to a mobility platform such that it can be positioned independently of the position of the first device and the other antennas in response to a control signal generated by the apparatus.

Each antenna may be configured to operate on a different radio frequency.

The antenna(s) may be attached to the first device, and the first device may be attached to a mobility platform such that the antenna(s) can be positioned by positioning of the first device in response to a control signal generated by the apparatus.

The mobility platform may comprise an electrical motor configured to position the antenna(s).

The apparatus may form part of the first or second device.

The first device may be a transmitter and the second device may be a receiver configured to receive data from the transmitter, or vice versa.

The first device may be one or more of a base station and a wireless access point and the second device may be one or more of a modem and a user device, or vice versa.

The second device may comprise a crane or robotic arm, and the first device may comprise a control unit for controlling operation of the crane or robotic arm.

The first device may be located on or within an elevator and the second device may be located on or within a corresponding elevator shaft, or vice versa.

The first device may be located at a production or assembly line and the second device may be located on part of a product being produced/assembled on the production or assembly line.

The first device may be located within a hospital and the second device may be located with a patient or clinician inside or outside of the hospital.

The first and second device may form part of a 3G, 4G or 5G network.

The apparatus may be one or more of an electronic device, a portable electronic device, a portable telecommunications device, a mobile phone, a personal digital assistant, a tablet, a phablet, a desktop computer, a laptop computer, a server, a smartphone, and a module for one or more of the same.

According to a further aspect, there is provided a method comprising:
mapping the value of a radio channel key performance indicator throughout a generally repeating cycle for two or more positions of an antenna of a first device, the value of the radio channel key performance indicator varying with changes in a radio environment between the first device and a second device for a given antenna position; and
using the mapped value of the radio channel key performance indicator to determine at least one position of the antenna for use in controlling the positioning of the antenna to achieve at least one acceptable value of the radio channel key performance indicator.

The steps of any method disclosed herein do not have to be performed in the exact order disclosed, unless explicitly stated or understood by the skilled person.

Corresponding computer programs for implementing one or more steps of the methods disclosed herein are also within the present disclosure and are encompassed by one or more of the described example embodiments.

One or more of the computer programs may, when run on a computer, cause the computer to configure any apparatus, including a battery, circuit, controller, or device disclosed herein or perform any method disclosed herein. One or more of the computer programs may be software implementations, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

One or more of the computer programs may be provided on a computer readable medium, which may be a physical computer readable medium such as a disc or a memory device, or may be embodied as a transient signal. Such a transient signal may be a network download, including an internet download.

The present disclosure includes one or more corresponding aspects, example embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:—

FIG. 1 shows one example of a radio environment between a first device and a second device;

FIG. 2 shows how signal reliability varies with fading margin for different orders of antenna diversity according to Rayleigh fading;

FIG. 3 shows an apparatus configured to perform the method described herein;

FIG. 4 shows a simulated elevator used to illustrate how a radio channel key performance indicator can vary with changes in the radio environment;

FIG. 5 shows how the simulated signal pathloss varies with distance between the first and second devices of FIG. 4 for two different antenna positions;

FIG. 6 shows how the simulated signal pathloss varies with distance between the first and second devices of FIG. 4 for many different antenna positions;

FIG. 7 shows a map of the simulated signal pathloss throughout the generally repeating cycle of FIG. 6;

FIG. 8 shows the antenna positioning required to achieve at least one acceptable value of simulated signal pathloss throughout the generally repeating cycle of FIG. 6;

FIG. 9 shows how the simulated signal pathloss varies with distance between the first and second devices of FIG. 4 for two different antennas;

FIG. 10 shows a map of the simulated signal pathloss throughout the generally repeating cycle of FIG. 9;

FIG. 11 shows how the simulated signal pathloss varies for many different pairs of antenna positions;

FIG. 12 shows how the real-world measured reference signal received power varies with distance between the first and second devices of FIG. 4 for various different positions of a co-polarized antenna;

FIG. 13 shows how the real-world measured reference signal received power varies with distance between the first and second devices of FIG. 4 for various different positions of an x-polarized antenna;

FIG. 14 shows the antennas of the first device attached to a mobility platform;

FIG. 15 shows the first device with antennas attached to a mobility platform;

FIG. 16 shows the method described herein; and

FIG. 17 shows a computer-readable medium comprising a computer program configured to perform, control or enable the method of FIG. 16.

### DESCRIPTION OF SPECIFIC ASPECTS/EMBODIMENTS

Ultra-reliable low latency communication (URLLC) is a new area for wireless communication, and is considered as one of the 3 key pillars in 5th generation cellular networks (the other two being enhanced mobile broadband and massive machine type of communication). URLLC potentially opens a wide variety of new use cases for wireless networks in various domains, such as industry automation and eHealth. URLLC sets more stringent optimization criteria for the network deployments: the network must support ultra-high reliability (e.g. 99.999% or higher); and in some cases extremely low e2e latency and jitter (e.g. guaranteed delay of 10 ms or lower).

Radio environments between a first device and a second device can vary over time. These variations may be caused by changes in: the distance between an antenna of the first device and an antenna of the second device; the orientation of an antenna of the first device and/or an antenna of the second device; the presence, number, positioning and/or activity of interfering devices located within the radio environment; the presence, number and/or positioning of objects located within the radio environment; and the atmospheric conditions and/or composition within the radio environment. Furthermore, one or more of these changes can cause variations in radio channel key performance indicators such as signal strength, pathloss, reference signal received power, reference signal received quality, received signal strength indicator, reliability, latency, jitter, coverage, capacity, data transfer rate, rank indicator, modulation and coding scheme indicator, and level of interference.

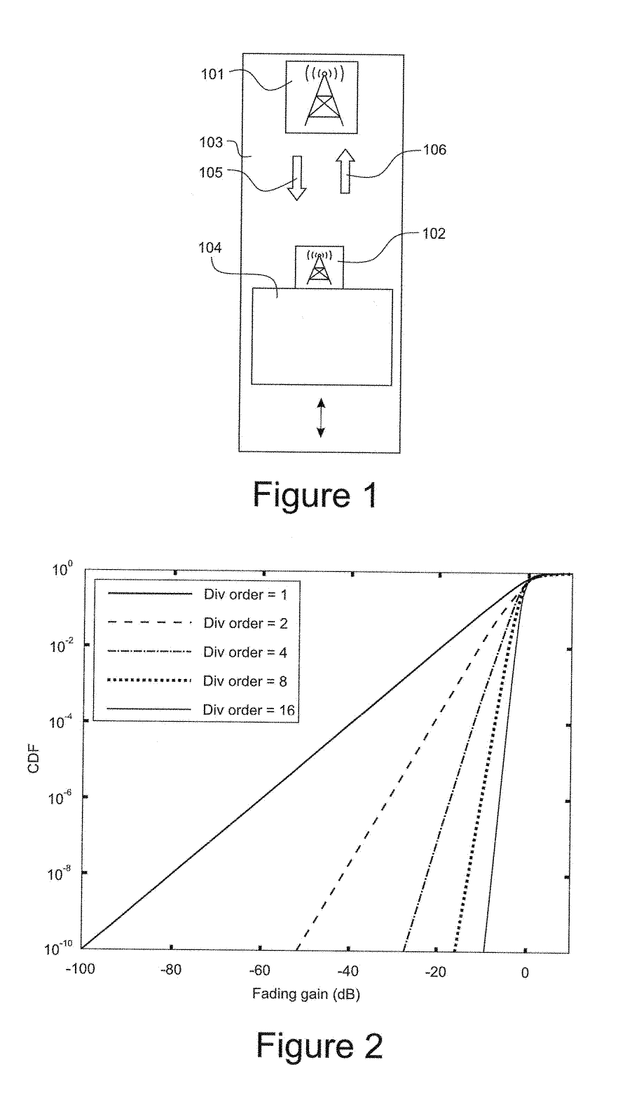

FIG. 1 shows an example of a radio environment between a first device 101 and a second device 102. In this example, the first device 101 is a base station located on the ceiling of an elevator shaft 103 and the second device 102 is a modem located on the roof of an elevator cabin 104 that is configured to move up and down the elevator shaft 103. The first device 101 is configured to transmit control messages 105 to control movement of the elevator cabin 104 and the second device 102 is configured to transmit acknowledgements of the received control messages 105. In this scenario, the radio environment changes mainly due to movement of the elevator cabin 104 (i.e. it varies with the distance between the base station 401 and modem 402 as the elevator 413 moves up and down the elevator shaft 412 with the possibility of deep fades when the elevator cabin 104 stops at certain floors). These changes in the radio environment can decrease the reliability of the connection and even prevent the first device 101 from receiving the information sent from the second device 102 or vice versa.

The reliability of a radio channel can be improved by introducing diversity techniques (time, frequency and spatial diversity), more robust channel coding, and interference mitigation. Higher diversity, however, requires more spatially-uncorrelated antennas and spectrum to be deployed, which reduces spectral efficiency and increases deployment costs. It is also difficult to achieve a highly accurate prediction of a radio channel. There are currently no practical methods to determine this with the accuracy required by URLLC. Furthermore, channel characteristics vary over time due to changes in the radio environment (e.g. moving/nomadic objects, temperature changes, changes in building construction, etc.).

To overcome this problem, designers of wireless URLLC networks could potentially apply high fading margins assuming that radio channels follow some expected fading distribution (such as Rayleigh fading) and that certain diversity order can be achieved within the area of interest with the planned deployment.

FIG. 2 shows how signal reliability varies with fading margin for different orders of antenna diversity according to Rayleigh fading. However, the use of higher fading margins creates two issues: large fading margins result in a poorer link budget (site density must be increased accordingly, which increases deployment costs exponentially); and some level of uncertainty will remain (channel may not be following Rayleigh fading, and may be more correlated than expected).

Current 4th generation wireless network deployments are targeted mainly to serve the needs of mobile broadband services, which typically benefit from high data rates but tolerate tens or even hundreds of millisecond latencies. Therefore, in the network planning and optimization, focus has been mainly on improving network coverage, capacity and user data rates.

A plethora of network planning tools for mobile broadband networks have been developed by network vendors, operators, and SMEs. Typical state-of-the-art radio network planning tools utilize 3D maps and ray-tracing to predict the radio propagation, which is then fed as an input to link and system level simulations to estimate the key performance indicators. Additionally, propagation models may have been calibrated with field measurements to better match the radio environment.

Current network planning and optimization methodologies have proven to achieve a reasonably good match with real-world network behaviour on a macroscopic level which has enabled the deployment of wireless networks that can deliver excellent quality mobile broadband services. However, these methodologies have not been designed to optimize ultra-high reliability.

There are also research attempts ongoing to improve the channel prediction accuracy, e.g. by generating highly accurate images of the environment via 3D laser scanning. It remains to be seen how much these new methods will improve the prediction accuracy. Even with highly accurate 3D maps, channel prediction is a non-trivial task, and there are also practical problems such as computational complexity and difficulties to model the radio propagation accurately enough. Furthermore, since the environment is dynamic, highly accurate predictions will become invalid over time.

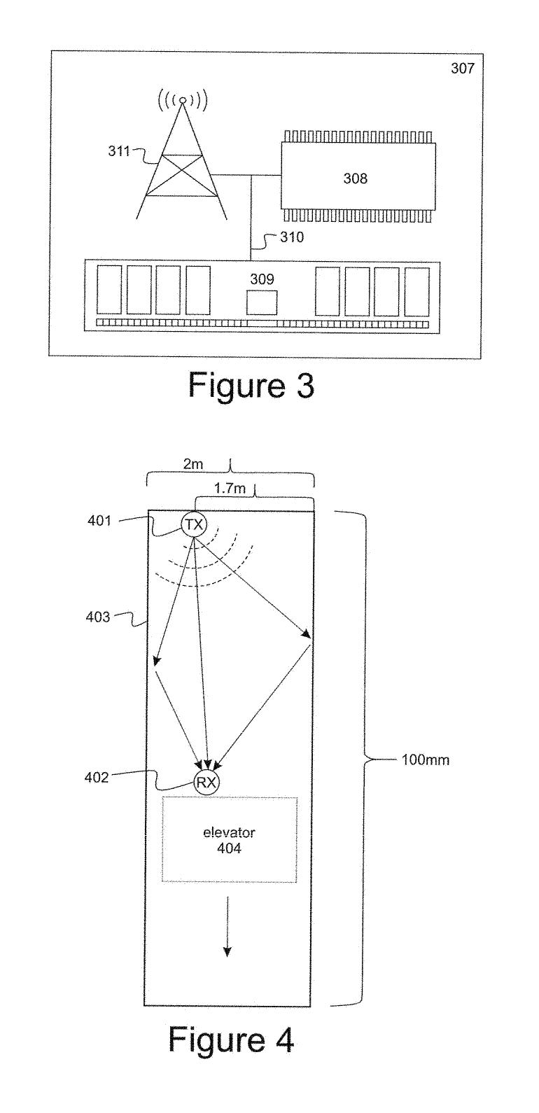

FIG. 3 shows an apparatus 307 which may be configured to address one or more of these issues. The apparatus 307 comprises a processor 308 and memory 309 (including computer program code) which are electrically connected to one another by a data bus 310. Furthermore, the apparatus 307 may be one or more of an electronic device, a portable electronic device, a portable telecommunications device, a mobile phone, a personal digital assistant, a tablet, a phablet, a desktop computer, a laptop computer, a server, a smartphone, a transmitter, a receiver, a base station, a wireless access point, a modem, and a module for one or more of the same.

The processor 308 may be configured for general operation of the apparatus 307 by providing signalling to, and receiving signalling from, the other components to manage their operation. The memory 309 may be configured to store computer code configured to perform, control or enable operation of the apparatus 307. The memory 309 may also be configured to store settings for the other components. The processor 308 may access the memory 309 to retrieve the component settings in order to manage the operation of the other components.

In some cases (as shown in FIG. 3), the apparatus 307 also comprises a transceiver 311 configured to transmit data to, and receive data from, one or more other devices (e.g. the first 101 and second 102 devices of FIG. 1) via a wired and/or wireless connection.

The apparatus 307 is configured to map the value of a radio channel key performance indicator throughout a generally repeating cycle for two or more positions of an antenna of a first device 101 (the value of the radio channel key performance indicator varying with changes in a radio environment between the first device 101 and a second device 102 for a given antenna position), and use the mapped value of the radio channel key performance indicator to determine at least one position of the antenna for use in controlling the positioning of the antenna to achieve at least one acceptable value of the radio channel key performance indicator. The apparatus 307 may be configured to map one or more of the absolute value, direction of change in value and rate of change in value of the radio channel key performance indicator throughout the generally repeating cycle.

The present approach takes advantage of the fact that changes in a radio environment (and therefore in one or more radio channel key performance indicators) typically follow a cyclic pattern which repeats in one or more of time, space and state of the radio environment. For example, one or more radio channel key performance indicators of the radio environment illustrated in FIG. 1 may exhibit a spatially-repeating pattern as the elevator cabin 104 moves within the elevator shaft 103. If there was a second elevator cabin in the elevator shaft 103 which was found to interfere with the signal at the first elevator cabin 104 when the two elevators were on the same floor, then the cycle in the value of the radio channel key performance indicator may also be considered to generally repeat based on the presence (first state) or absence (second state) of the second elevator. The cyclic nature of the radio channel key performance indicators makes it possible to predict the future state of the radio environment based on previous observations, and adjust the positioning of the antenna of the first device 101 proactively to compensate for the changes in the radio environment. This is rather different to the existing methods described previously in which the focus is to find the optimal antenna positions reactively without memory of the past.

It is important to note that radio channel key performance indicators will not usually exhibit identical values at the same point in different cycles, but will often follow a similar trend and in some cases may have substantially the same values (hence the expression “generally repeating cycle”).

This approach helps to lower the fading margin when planning the static network by improving the coverage in local or temporary fading dips (and thus reduce the number of required access points). It also reduces the need for network optimisation, which would normally require extensive field measurements and continuous adjustments if the environment or connectivity needs are dynamic. In addition, the present approach can dynamically improve reliability and reduce the required number of antennas to achieve diversity. It may also be particularly applicable for use cases in which reactive methods are unsuitable due to latency requirements or their limitation to static environments.

It is worth noting, however, that some fading margin may still be required if the changes in antenna position are unable to follow fast fading variations. Nevertheless, the present approach should help to reduce the slow fading and interference margins for the network by several dBs or even tens of dBs, which offers a significant improvement in terms of deployment costs.

FIG. 4 shows a simulated elevator 404 used to illustrate how a radio channel key performance indicator can vary with changes in the radio environment. The signal pathloss was simulated as the elevator 404 was lowered from the top of the elevator shaft 403 to a distance of 100 m. This simulation was repeated with the base station antenna 401 positioned at different distances from the right-hand side of the elevator shaft 403. The signal pathloss was simulated using a simplified ray-tracing model which considered line of sight and reflections from both walls of the elevator shaft 403.

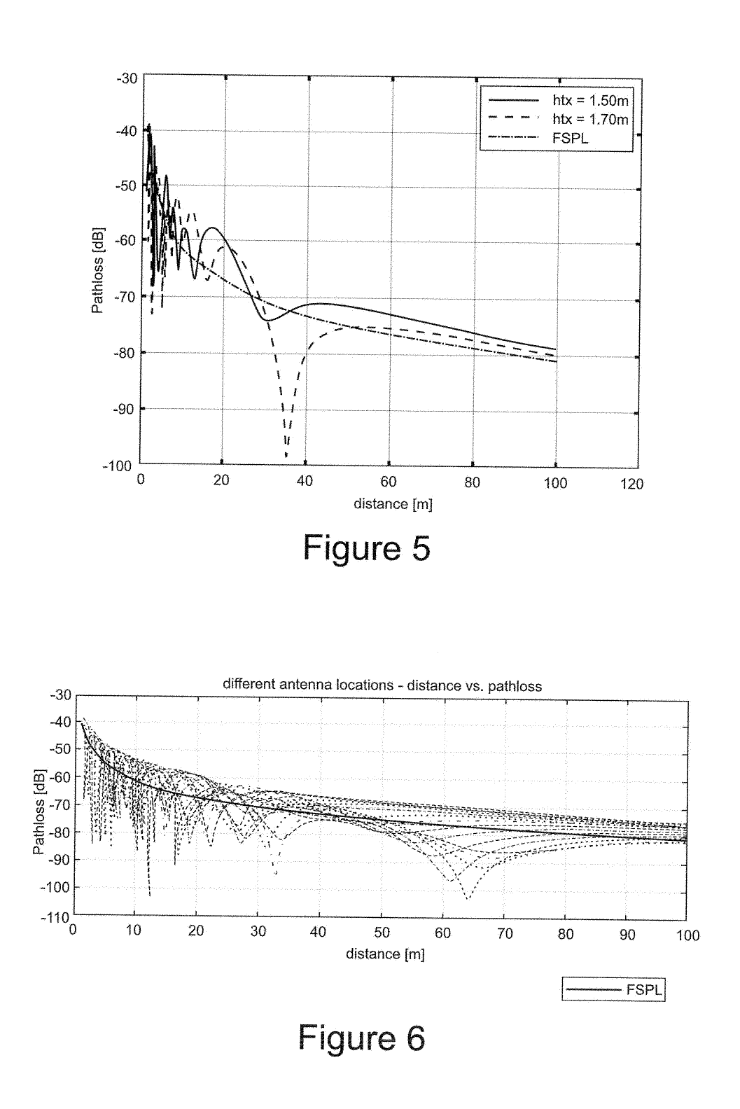

FIG. 5 shows how the signal pathloss varied with distance between the base station 401 and modem 402 of FIG. 4 for the antenna positioned at 1.5 m and 1.7 m from the elevator wall, together with the free space path loss (FSPL). As can be seen, the signal pathloss experienced deep fade around 38 m when the base station antenna 401 was positioned at 1.7 m. This was avoided when the base station antenna 401 was positioned at 1.5 m.

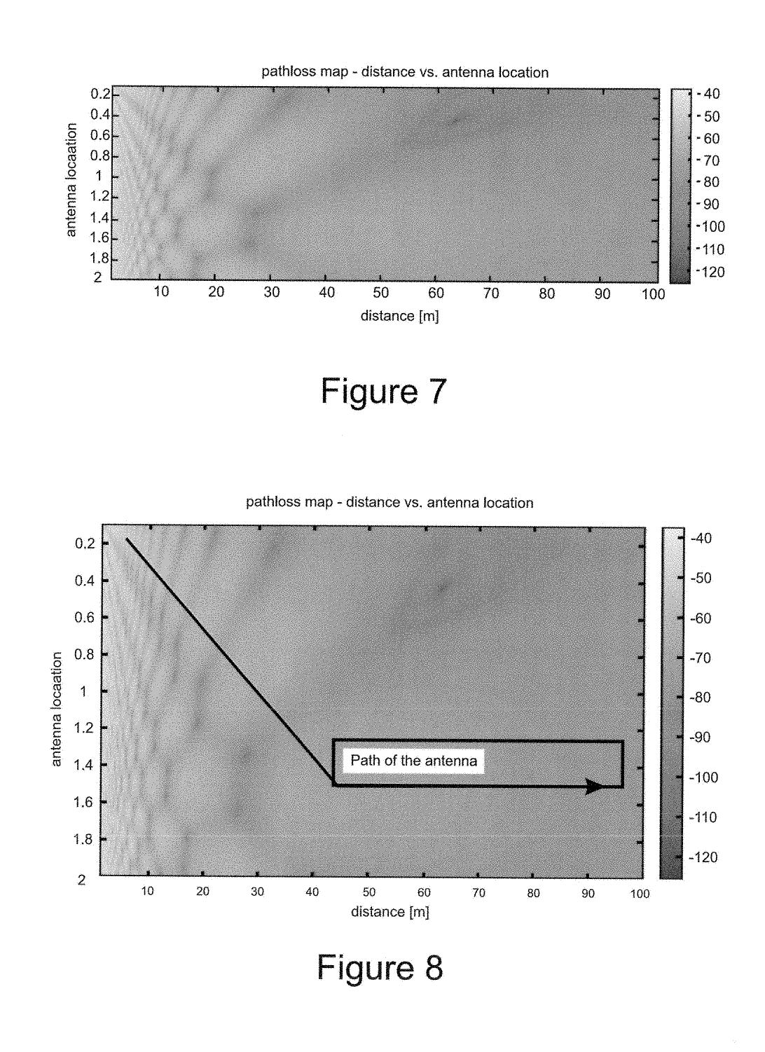

FIG. 6 shows how the signal pathloss varied with distance between the base station 401 and modem 402 of FIG. 4 for a range of different antenna positions ranging from 0 m to 2 m from the right-hand side of the elevator shaft 403, whilst FIG. 7 shows a map of the signal pathloss throughout the generally repeating cycle (i.e. from the top of the elevator shaft to a depth of 100 m). These graphs show that deep fades occurred at various distances between the base station 401 and modem 402.

The present apparatus 307 may be configured to compensate for these fades in different ways. For example, the apparatus 307 may be configured to use the mapped value of the radio channel key performance indicator to determine respective positions of the antenna at different stages of the generally repeating cycle. In this way, the antenna could be moved during movement of the elevator to achieve an acceptable value of the radio channel key performance indicator at each of the different stages.

FIG. 8 shows the map of FIG. 7 overlaid with the antenna positioning required to achieve at least one acceptable value of signal pathloss throughout the generally repeating cycle. In this case, the acceptable value was an optimum value, but it could be a particular value, a value which is greater than or less than a threshold value, or even a range of values.

Alternatively, the apparatus may be configured to use the mapped value of the radio channel key performance indicator to determine a fixed position of the antenna throughout the generally repeating cycle. For example, a fixed position may be determined which can achieve an average value of the radio channel key performance indicator (provided that this average value is considered to be acceptable). In this scenario, there is no need to move the antenna again during the generally repeating cycle once it is in the fixed position. Fixed antenna positions may also be used when the first device comprises a plurality of antennas for transmitting the same signal, as described in more detail below.

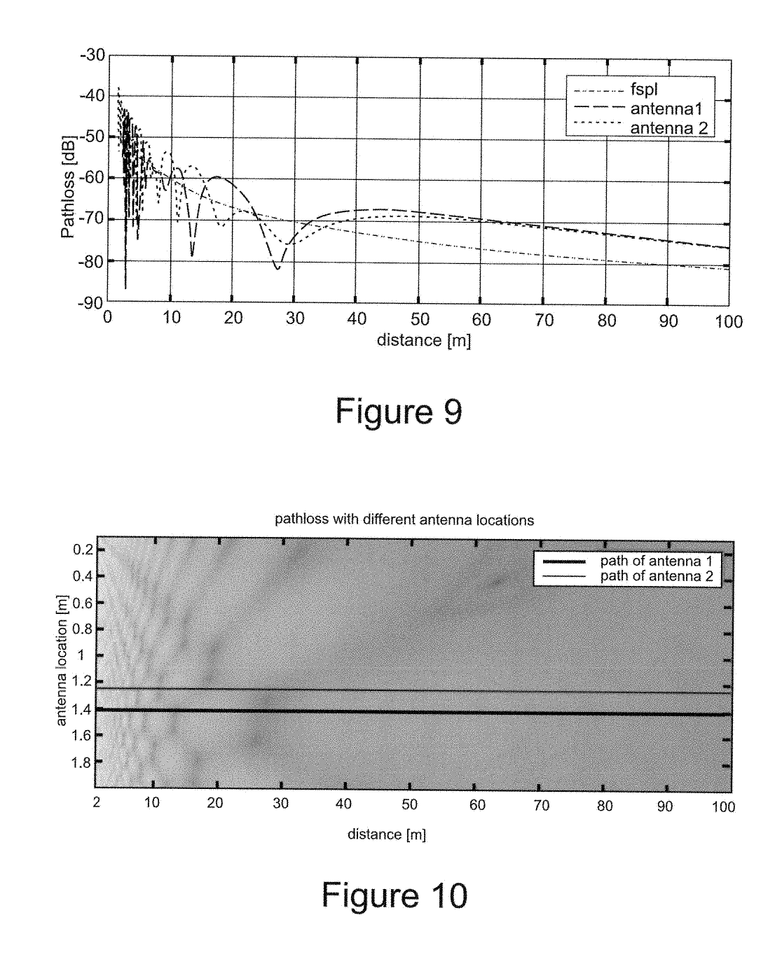

FIG. 9 shows how the signal pathloss varied with distance between the base station 401 and modem 402 of FIG. 4 for two different base station antennas, whilst FIG. 10 shows a map of the signal pathloss throughout the generally repeating cycle (i.e. from the top of the elevator shaft to a depth of 100 m). In this scenario, the apparatus 307 may be configured to determine fixed positions for both antennas to achieve the acceptable value of the radio channel key performance indicator. In the example of FIG. 10, the fixed positions of the antennas were determined such that the signal strength was maximised in the worst channel conditions.

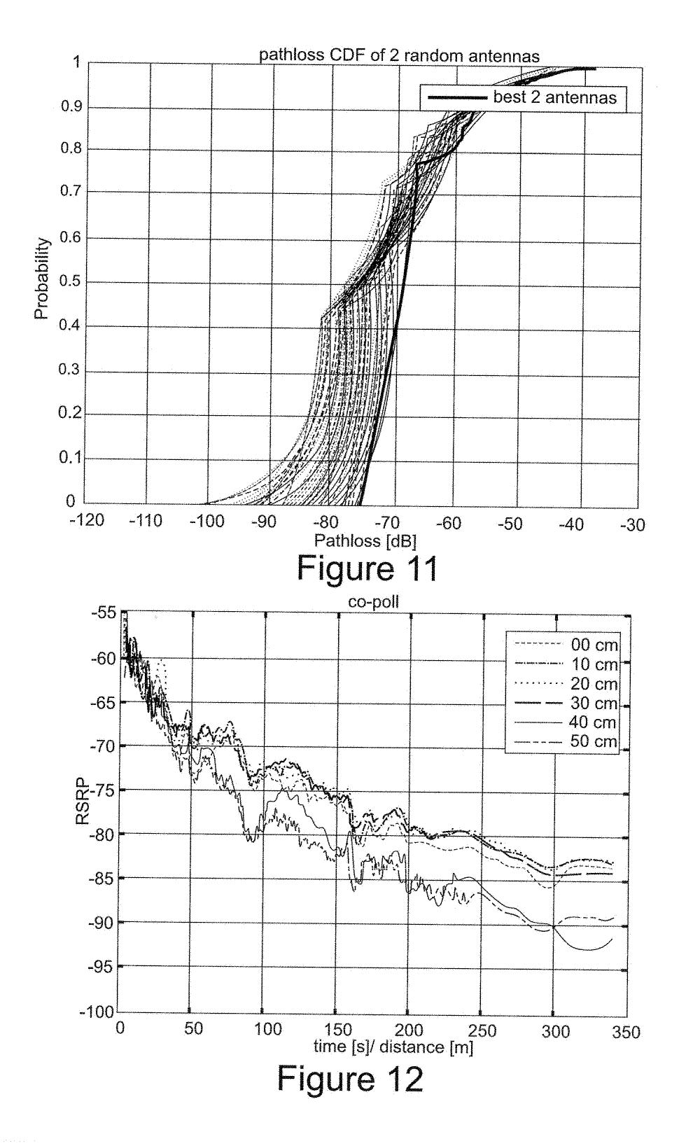

FIG. 11 shows how the signal pathloss varied for many different pairs of antenna positions. As can be seen from this graph, the fixed antenna positions mentioned above were found to achieve a gain of more than 10 dBs in comparison to the average distribution tail determined using random placement of the two antennas.

To demonstrate the potential gains of the present approach further, real-world measurements were made using an LTE base station located on the ceiling of a 300 m deep elevator shaft and an LTE modem located on the roof of a corresponding elevator cabin. The modem comprised two antennas: a first antenna which was co-polarized with the base station antenna; and a second antenna which was oriented 90° with respect to the base station antenna to achieve x-polarization. The reference signal received power (RSRP) at each modem antenna was measured as the elevator was driven down the shaft at a speed of one meter per second. After each cycle, the modem antennas were displaced 10 cm on a one-dimensional line on the roof of the elevator cabin and the measurement cycle repeated until a maximum displacement of 50 cm was reached.

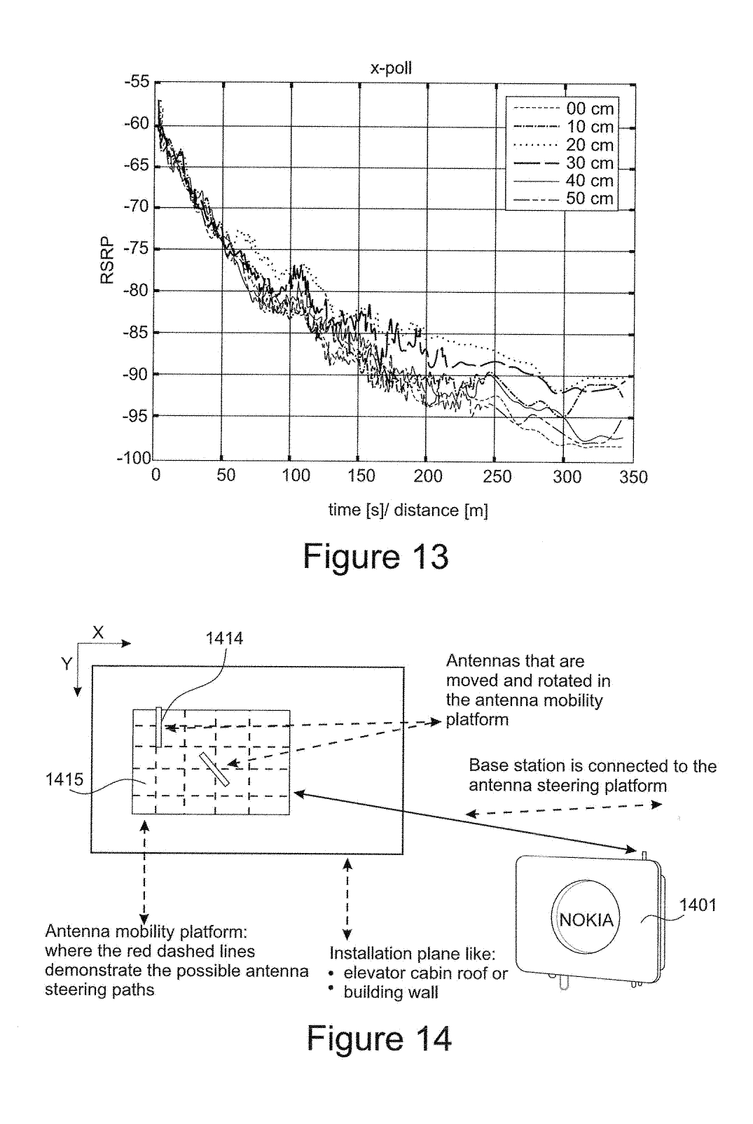

FIGS. 12 and 13 show how the RSRP varies with distance between the base station and modem for each position of the co-polarized and x-polarized modem antenna, respectively. As can be seen from both graphs, the difference between the worst and best case RSRP at the bottom of the elevator shaft (300 seconds or meters in x-axis) was around 10 dBs. The best-case performance was achieved with a 0-30 cm antenna displacement and the worst-case performance was achieved with a 40 cm antenna displacement. In this example, therefore, antenna mobility between 10 and 40 cm would have given around 10 dB gain for the link budget. Additionally, the x-polarized antenna measurements, which were approximately 10 dB worse than the co-polarized antenna measurements, illustrate the importance of antenna rotation. This experiment demonstrates the potential gain that can be achieved by adjusting both the antenna location and orientation to compensate for changes in the radio environment.

In some cases, the present apparatus 307 may be configured to control the positioning of the antenna of the first device (e.g. the base station or modem described previously) once the most suitable antenna positions have been determined from the mapped value of the radio channel key performance indicator. In this scenario, the apparatus 307 may be configured to control the location of the antenna in one, two or three dimensions and/or the orientation of the antenna about one or more axes. Furthermore, when the first device comprises a plurality of antennas (which may be operating on the same or different radio frequencies), the present apparatus 307 may be configured to determine and control the positioning of each antenna to achieve the at least one acceptable value of the radio channel key performance indicator.

FIG. 14 shows how the antennas 1414 of the first device 1401 can be attached to a mobility platform 1415 to enable their positioning to be controlled by the present apparatus 307. In this example, each antenna 1414 is attached to the mobility platform 1415 such that it can be positioned independently of the position of the first device 1401 and the other antennas 1414 in response to a control signal generated by the apparatus 307. Also, although the antennas 1414 in FIG. 14 are shown as being integral to the first device 1401 via the mobility platform 1415 being connected to the first device 1401, they could be external to the first device 1401 (e.g. the mobility platform 1415 may be detached and possibly remote from the first device 1401).

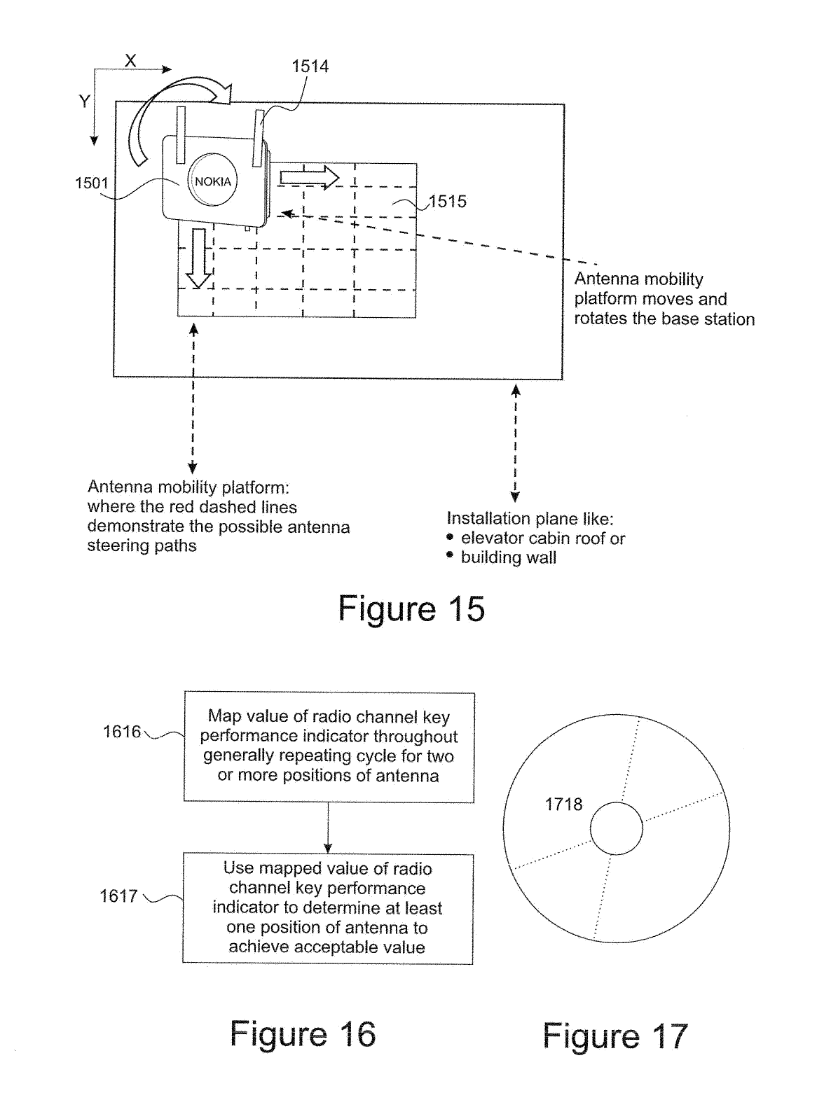

FIG. 15 shows another example in which a first device 1501 with integral antennas 1514 is attached to a mobility platform 1515 such that the antennas 1514 can be positioned by positioning of the first device 1501 in response to a control signal generated by the apparatus 307. In this example, therefore, the first device 1501 and integral antennas 1514 are positioned together by the mobility platform 1515 as a single unit rather than the antennas 1514 being positioned independently of the first device 1501. In the examples of FIGS. 14 and 15, the mobility platform 1415, 1515 may comprise an electrical motor configured to position the antennas 1514 and/or first device 1501.

As mentioned previously, the present apparatus 307 is configured to map the value of a radio channel key performance indicator throughout a generally repeating cycle for two or more positions of an antenna of the first device, and use the mapped value of the radio channel key performance indicator to determine at least one position of the antenna for use in controlling the positioning of the antenna to achieve at least one acceptable value of the radio channel key performance indicator. The apparatus 307 may also be configured to control the positioning of the antenna according to the at least one determined position of the antenna. In practice, each of these operations could be performed remotely from the first apparatus. As such, the present apparatus 307 may or may not form part of the first device. In some cases, the apparatus 307 may be a remote server, or it may form part of the second device. The location of the present apparatus 307 is not critical provided the apparatus 307 has access to the values of a radio channel key performance indicator throughout a generally repeating cycle. If the apparatus 307 is also configured to control the positioning of the antenna of the first device, then there would need to be a communication link to enable the apparatus 307 to send a control signal to the first device. This communication link could, however, be wired or wireless (e.g. using the transceiver 311 of FIG. 3).

In the examples described above, the first device was a transmitter (in the form of a base station) and the second device was a receiver (in the form of a modem) configured to receive data from the transmitter, or vice versa. Nevertheless, there are many other use cases in which one or more radio channel key performance indicators exhibit a generally repeating cycle and could benefit from a more robust connection between the first and second devices. For example: the first device may be a wireless access point and the second device may be a user device (or vice versa); the second device may be a crane or robotic arm and the first device may be a control unit for controlling operation of the crane or robotic arm; the first device may be located at a production or assembly line and the second device may be located on part of a product being produced/assembled on the production or assembly line; or the first device may be located within a hospital and the second device may be located with a patient or clinician inside or outside of the hospital. In each of these examples, there is some degree of periodicity in the radio environment. As such, the present apparatus may be used to determine (and possibly control) the positioning of the antenna(s) of the first device to achieve at least one acceptable value of a radio channel key performance indicator to improve the connection between the first and second devices despite changes in the radio environment. Achieving URLLC is particularly beneficial for safety-critical applications such as port automation and remote surgery.

FIG. 16 shows the main steps 1616-1617 of the method described herein. The method generally comprises: mapping the value of a radio channel key performance indicator throughout a generally repeating cycle for two or more positions of an antenna of a first device 1616; and using the mapped value of the radio channel key performance indicator to determine at least one position of the antenna to achieve at least one acceptable value of the radio channel key performance indicator 1617.

FIG. 17 shows a computer/processor readable medium 1718 providing a computer program. The computer program may comprise computer code configured to perform, control or enable one or more of the method steps 1616-1617 of FIG. 16 using at least part of the apparatus described herein. In this example, the computer/processor readable medium 1718 is a disc such as a digital versatile disc (DVD) or a compact disc (CD). In other embodiments, the computer/processor readable medium 1718 may be any medium that has been programmed in such a way as to carry out an inventive function. The computer/processor readable medium 1718 may be a removable memory device such as a memory stick or memory card (SD, mini SD, micro SD or nano SD).

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus/device and/or other features of particular mentioned apparatus/device may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on one or more memories/processors/functional units.

In some embodiments, a particular mentioned apparatus/device may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus comprising a processor and memory including computer program code, the memory and computer program code configured to, with the processor, enable the apparatus at least to:
map the value of a radio channel key performance indicator throughout a generally repeating cycle for two or more positions of an antenna of a first device, wherein the radio channel key performance indicator comprises one or more of signal strength, pathloss, reference signal received power, reference signal received quality, received signal strength indicator, reliability, latency, jitter, coverage, capacity, data transfer rate, rank indicator, modulation and coding scheme indicator, and level of interference, and wherein the value of the radio channel key performance indicator varies with changes in a radio environment between the first device and a second device for a given antenna position; and
use the mapped value of the radio channel key performance indicator to determine at least one position of the antenna for use in controlling the positioning of the antenna to achieve at least one acceptable value of the radio channel key performance indicator.

2. The apparatus of claim 1, wherein the apparatus is configured to use the mapped value of the radio channel key performance indicator to determine respective positions of the antenna at different stages of the generally repeating cycle for use in controlling the positioning of the antenna to achieve an acceptable value of the radio channel key performance indicator at each of said different stages.

3. The apparatus of claim 1, wherein the apparatus is configured to use the mapped value of the radio channel key performance indicator to determine a fixed position of the antenna throughout the generally repeating cycle for use in controlling the positioning of the antenna to achieve the at least one acceptable value of the radio channel key performance indicator.

4. The apparatus of claim 1, wherein the at least one acceptable value of the radio channel key performance indicator is an optimum value, a particular value, an average value, a value which is greater or less than a threshold value, or a range of values.

5. The apparatus of claim 1, wherein the apparatus is configured to map one or more of the absolute value, change in value, direction of change in value and rate of change in value of the radio channel key performance indicator throughout the generally repeating cycle.

6. The apparatus of claim 1, wherein the cycle in the value of the radio channel key performance indicator generally repeats in one or more of time, space and state of the radio environment.

7. The apparatus of claim 1, wherein the value of the radio channel key performance indicator varies with one or more of the following changes in the radio environment:
the distance between the antenna of the first device and an antenna of the second device;
the orientation of the antenna of the first device and/or the antenna of the second device;
the presence, number, positioning and/or activity of interfering devices located within the radio environment;
the presence, number and/or positioning of objects located within the radio environment; and
the atmospheric conditions and/or composition within the radio environment.

8. The apparatus of claim 1, wherein the apparatus is configured to control one of the following:
a) the positioning of the antenna according to the at least one determined position of the antenna,
or
b) one or more of the location and orientation of the antenna,
or
c) control the location of the antenna in one, two or three dimensions,
or
d) the orientation of the antenna about one or more axes.

9. The apparatus of claim 8, wherein the antenna is attached to a mobility platform such that it can be positioned independently of the position of the first device in response to a control signal generated by the apparatus.

10. The apparatus of claim 1, wherein the first device comprises a plurality of antennas, and wherein the apparatus is configured to determine and control the positioning of each antenna to achieve the at least one acceptable value of the radio channel key performance indicator.

11. A Method to:
map the value of a radio channel key performance indicator throughout a generally repeating cycle for two or more positions of an antenna of a first device, wherein the radio channel key performance indicator comprises one or more of signal strength, pathloss, reference signal received power, reference signal received quality, received signal strength indicator, reliability, latency, jitter, coverage, capacity, data transfer rate, rank indicator, modulation and coding scheme indicator, and level of interference, and wherein the value of the radio channel key performance indicator varies with changes in a radio environment between the first device and a second device for a given antenna position; and
use the mapped value of the radio channel key performance indicator to determine at least one position of the antenna for use in controlling the positioning of the antenna to achieve at least one acceptable value of the radio channel key performance indicator.

12. The method of claim 11, wherein the mapped value of the radio channel key performance indicator is used to determine respective positions of the antenna at different stages of the generally repeating cycle for use in controlling the positioning of the antenna to achieve an acceptable value of the radio channel key performance indicator at each of said different stages.

13. The method of claim 11, wherein the apparatus is configured to use the mapped value of the radio channel key performance indicator to determine a fixed position of the antenna throughout the generally repeating cycle for use in controlling the positioning of the antenna to achieve the at least one acceptable value of the radio channel key performance indicator.

14. The method of claim 11, wherein the at least one acceptable value of the radio channel key performance indicator is an optimum value, a particular value, an average value, a value which is greater or less than a threshold value, or a range of values.

15. The method of claim 11, wherein the apparatus is configured to map one or more of the absolute value, change in value, direction of change in value and rate of change in value of the radio channel key performance indicator throughout the generally repeating cycle.

16. The method of claim 11, wherein the cycle in the value of the radio channel key performance indicator generally repeats in one or more of time, space and state of the radio environment.

17. The method of claim 11, wherein the value of the radio channel key performance indicator varies with one or more of the following changes in the radio environment:
the distance between the antenna of the first device and an antenna of the second device;
the orientation of the antenna of the first device and/or the antenna of the second device;
the presence, number, positioning and/or activity of interfering devices located within the radio environment;
the presence, number and/or positioning of objects located within the radio environment; and
the atmospheric conditions and/or composition within the radio environment.

18. The method of claim 11, wherein the apparatus is configured to control one of the following:
a) the positioning of the antenna according to the at least one determined position of the antenna,
or
b) one or more of the location and orientation of the antenna,
or
c) control the location of the antenna in one, two or three dimensions,
or
d) the orientation of the antenna about one or more axes.

19. The method of claim 18, wherein the antenna is attached to a mobility platform such that it can be positioned independently of the position of the first device in response to a control signal generated by the apparatus.

20. The method of claim 11, wherein the first device comprises a plurality of antennas, and wherein the apparatus is configured to determine and control the positioning of each antenna to achieve the at least one acceptable value of the radio channel key performance indicator.

21. A method comprising:
mapping the value of a radio channel key performance indicator throughout a generally repeating cycle for two or more positions of an antenna of a first device, the value of the radio channel key performance indicator varying with changes in a radio environment between the first device and a second device for a given antenna position; and
using the mapped value of the radio channel key performance indicator to determine at least one position of the antenna for use in controlling the positioning of the antenna to achieve at least one acceptable value of the radio channel key performance indicator.

22. A non-transitory computer readable medium in which a computer program code is stored, the computer program code causing an apparatus to perform the following when executed by a processor:
mapping the value of a radio channel key performance indicator throughout a generally repeating cycle for two or more positions of an antenna of a first device, the value of the radio channel key performance indicator varying with changes in a radio environment between the first device and a second device for a given antenna position; and
using the mapped value of the radio channel key performance indicator to determine at least one position of the antenna for use in controlling the positioning of the antenna to achieve at least one acceptable value of the radio channel key performance indicator.
